(19) United States
(12) Patent Application Publication
(10) Pub. No.: US 2011/0300256 A1
(43) Pub. Date: Dec. 8, 2011

(54) CHUNKS IN JELLY FOOD COMPOSITIONS

(76) Inventors: Annie Watelain, Lavieville (FR); Paulo Femandes, Amiens (FR)

(21) Appl. No.: 13/138,100

(22) PCT Filed: Dec. 30, 2009
(86) PCT No.: PCT/US2009/006756

§ 371 Date: Aug. 15, 2011

Related U.S. Application Data
(60) Provisional application No. 61/204,395, filed on Jan. 6, 2009.

(51) Int. Cl. A23L 1/054; A23K 1/00

(52) U.S. Cl. 426/2; 426/103; 426/573

(57) ABSTRACT

The invention provides a chunks in jelly food composition comprising chunks in jelly in a chunks to jelly ratio of from about 25:75 to about 60:40, wherein the jelly comprises from about 0.01 to about 1% gellan, from about 0.01 to about 1% deacetylated xanthan, and from about 0.01 to about 1% chelating agent. The jelly maintains its viscosity during the manufacturing process and ensures an even distribution of the chunks in the chunks in jelly food composition.

### CROSS REFERENCE TO RELATED APPLICATIONS

This application is a national stage application under 35 U.S.C. §371 of PCT/US2009/006756 filed Dec. 30, 2009, which claims priority to U.S. Provisional Application Ser. No. 61/204395 filed Jan. 6, 2009, the disclosures of which are incorporated herein by reference.

### BACKGROUND OF THE INVENTION

1. Field of the Invention

The invention relates generally to food compositions and particularly to chunks in jelly food compositions.

2. Description of Related Art

Chunks in jelly food compositions are typically produced by making a fluid jelly using k-carrageenan, carob, guar, and xanthan as gum ingredients. The jelly is placed in a container and hot chunks (typically >70° C.) are mixed with the fluid jelly. The chunks in jelly mixture is placed in a container, sealed, and retorted to produce a chunks in jelly food composition. During the process, the jelly should maintain a viscosity that supports the chunks and keeps the chunks evenly dispersed in the jelly. However, when the hot chunks are mixed with the jelly, the guar gum breaks down and the jelly loses some of its viscosity. This loss of viscosity causes the jelly to lose its ability to keep the chunks uniformly dispersed in the jelly. The chunks typically settle toward the bottom of the container. When this happens, the resulting chunks in jelly food composition has an uneven chunk distribution with an unappealing appearance. There is, therefore, a need for new chunks in jelly food compositions that have an even and appealing distribution of chunks in the composition.

### SUMMARY OF THE INVENTION

It is, therefore, an object of the present invention to provide new chunks in jelly food compositions.

It is a further object of the invention to provide new jelly compositions useful for producing chunks in jelly food compositions.

It is another object of the invention to provide chunks in jelly food compositions with improved digestibility.

It is a further object of the invention to provide methods for improving fecal quality and consistency for animals consuming chunks in jelly food compositions.

It is another object of the invention to provide chunks in jelly food compositions with improved palatability.

One or more of these or other objects are achieved using novel chunks in jelly food compositions comprising chunks in jelly in a chunks to jelly ratio of from about 25:75 to about 60:40, wherein the jelly comprises from about 0.01 to about 1% gellan, from about 0.01 to about 1% deacetylated xanthan, from about 0.01 to about 1% chelating agent, and from about 0.01 to about 1% calcium salt. The use of this novel combination of gums in the required amounts produces a jelly that maintains its viscosity throughout the manufacturing process. The resulting chunks in jelly food compositions have an appealing appearance and desirable palatability based upon a relatively even distribution of chunks in the composition. In addition, the novel chunks in jelly food compositions have a beneficial affect on fecal quality and consistency based upon a reduction in the total amount of gums in the food composition, have an improved digestibility compared to prior art chunks in jelly food compositions because of the reduced amount of gums in the food compositions, and have an equal or improved palatability compared to prior art chunks in jelly food compositions.

Other and further objects, features, and advantages of the present invention will be readily apparent to those skilled in the art.

### DETAILED DESCRIPTION OF THE INVENTION

### Definitions

The term “food composition” means a product or composition that is intended for ingestion by an animal.

The term “animal” means any animal that could benefit from or enjoy the consumption of the food compositions of the present invention, including human, avian, bovine, canine, equine, feline, hicrine, lupine, murine, ovine, or porcine animals.

The term “companion animal” means domesticated animals such as cats, dogs, rabbits, guinea pigs, ferrets, hamsters, mice, gerbils, horses, cows, goats, sheep, donkeys, pigs, and the like.

All percentages expressed herein are by weight of the total weight of the composition unless expressed otherwise.

All ratios expressed herein are on a weight:weight (w/w) basis unless expressed otherwise.

As used herein, ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “a chunk”, “a method”, or “a food” includes a plurality of such “chunks”, “methods”, or “foods.” Similarly, the words “comprise”, “comprises”, and “comprising” are to be interpreted inclusively rather than exclusively. Likewise the terms “include”, “including” and “or” should all be construed to be inclusive, unless such a construction is clearly prohibited from the context. Similarly, the term “examples,” particularly when followed by a listing of terms, is merely exemplary and illustrative and should not be deemed to be exclusive or comprehensive.

The methods and compositions and other advances disclosed here are not limited to particular methodology, protocols, and reagents described herein because, as the skilled artisan will appreciate, they may vary. Further, the terminology used herein is for the purpose of describing particular embodiments only, and is not intended to, and does not, limit the scope of that which is disclosed or claimed.

Unless defined otherwise, all technical and scientific terms, terms of art, and acronyms used herein have the meanings commonly understood by one of ordinary skill in the art in the field(s) of the invention, or in the field(s) where the term is used. Although any compositions, methods, articles of manufacture, or other means or materials similar or equivalent to those described herein can be used in the practice of the present invention, the preferred compositions, methods, articles of manufacture, or other means or materials are described herein.

All patents, patent applications, publications, technical and/or scholarly articles, and other references cited or referred to herein are in their entirety incorporated herein by reference to the extent allowed by law. The discussion of those references is intended merely to summarize the assertions made therein. No admission is made that any such patents, patent applications, publications or references, or any portion thereof, are relevant, material, or prior art. The right to challenge the accuracy and pertinence of any assertion of such patents, patent applications, publications, and other references as relevant, material, or prior art is specifically reserved.

### The Invention

In one aspect, the invention provides chunks in jelly food compositions. The compositions comprise chunks in jelly in a chunks to jelly ratio of from about 25:75 to about 60:40, wherein the jelly comprises from about 0.01 to about 1% gellan, from about 0.01 to about 1% deacetylated xanthan, from about 0.01 to about 1% chelating agent, and from about 0.01 to about 1% calcium salt. In a preferred embodiment, the jelly further comprises from about 0.01 to about 1% guar. Typically, the jelly comprises from about 90% to about 98% water.

In various embodiments, the chunks to jelly ratio is about 30:70, 35:65, 40:60, 45:55, 50:50, and 55:45. Preferably, the chunks to jelly ratio is about ratio of 35:65, most preferably about 45:55.

In another aspect, the invention provides a jelly suitable for use in chunks in jelly food compositions. The jelly comprises from about 0.01 to about 1% gellan, from about 0.01 to about 1% deacetylated xanthan, from about 0.01 to about 1% chelating agent, and from about 0.01 to about 1% calcium salt. In a preferred embodiment, the jelly further comprises from about 0.01 to about 1% guar. Typically, the jelly comprises from about 90% to about 98% water.

In various embodiments, the jelly comprises from about 0.03 to about 0.7% gellan, preferably from about 0.05 to about 0.5% gellan.

In various embodiments, the jelly comprises from about 0.03 to about 0.7% deacetylated xanthan, preferably from about 0.05 to about 0.5% deacetylated xanthan.

In various embodiments, the jelly comprises from about 0.03 to about 0.7% guar, preferably from about 0.05 to about 0.5% guar.

The chelating agent is any chelating agent useful to produce chunks in jelly food compositions. Preferably, the chelating agent is sodium citrate, citric acid, malic acid, sodium gluconate, gluconic acid, tetra-sodium pyrophosphate, or sodium acid pyrophosphate. In various embodiments, the jelly comprises one or more chelating agents in amounts of from about 0.03 to about 0.7%, preferably from about 0.05 to about 0.5%.

The calcium salt is any soluble or partially soluble calcium salt useful to produce chunks in jelly food compositions. The calcium salt can be any equivalent calcium source that is soluble or partially soluble in water. Preferably, the calcium salt is calcium chloride, calcium citrate, calcium carbonate, calcium lactate, calcium nitrate, and calcium sulfate. In various embodiments, the jelly comprises one or more calcium salts in amounts of from about 0.03 to about 0.7%, preferably from about 0.05 to about 0.5%.

The chunks can be any suitable chunks known to skilled artisans. Any real meat chunk, real fish chunk, meat analog chunk, vegetable chunk, or combinations thereof are useful in the present invention. The chunks can contain meat, meat by-products, cereals, vegetable protein extracts, and the like. Chunk compositions and method for manufacturing chunks useful in the present invention are described in U.S. Pat. No. 5,132,137, U.S. Pat. No. 5,567,466, U.S. Pat. No. 6,436,463 (EP1294237B1), U.S. Pat. No. 4,781,939, U.S. Pat. No. 6,379,738, and U.S. Pat. No. 7,344,745. The chunks vary in size depending upon the animal that will consume the product, e.g., the type, age, health, or size of the animal. For example, chunk sizes suitable for dogs typically range from about 10 to 80 millimeters (mm), preferably 20 to 40 mm, on the longest side. Chunk sizes for cats typically range from 3 to 30 mm, preferably 8 to 20 mm, on the longest side.

In various embodiments, the compositions of the present invention comprise additional ingredients such as vitamins, minerals, amino acids, nucleic acids, fillers, palatability enhancers, binding agents, flavors, stabilizers, emulsifiers, sweeteners, colorants, buffers, salts, coatings, condiments, preservatives, and the like known to skilled artisans. Non-limiting examples of supplementary minerals include calcium, phosphorous, potassium, sodium, iron, chloride, boron, copper, zinc, magnesium, manganese, iodine, selenium, and the like. Non-limiting examples of supplementary vitamins include vitamin A, any of the B vitamins, vitamin C, vitamin D, vitamin E, and vitamin K, including various salts, esters, or other derivatives of the foregoing. Additional dietary supplements may also be included, for example, any form of niacin, pantothenic acid, inulin, folic acid, biotin, amino acids, and the like, as well as salts and derivatives thereof. Stabilizers include substances that tend to increase the shelf life of the composition such as preservatives, synergists and sequestrants, packaging gases, emulsifiers, thickeners, gelling agents, and humectants. Examples of emulsifiers and/or thickening agents include gelatin, cellulose ethers, starch, starch esters, starch ethers, and modified starches. Selection of the ingredients and their amounts is known to skilled artisans. Specific amounts for each additional ingredient will depend on a variety of factors such as the ingredient included in the composition; the species of animal; the animal's age, body weight, general health, sex, and diet; the animal's consumption rate; the purpose for which the food compositions is being administered to the animal; and the like. Therefore, the component and ingredient amounts may vary widely and may deviate from the preferred proportions described herein.

In other embodiments, the food compositions are formulated to provide “complete and balanced” nutrition for an animal, preferably a companion animal, according to standards established by the Association of American Feed Control Officials (AAFCO). In other embodiments, the food compositions are formulated as a companion animal food composition, including a dog or cat food composition. In various embodiments, the animal is a companion animal, preferably a dog or a cat, most preferably a dog.

The invention is based upon the discovery that a unique combination of gums can provide a jelly with a viscosity that keeps the chunks evenly distributed in the jelly during the manufacturing process required to produce a chunks in jelly food composition, typically from about 3000 to 4000 centipoises. This unique combination of gums maintains the viscosity required to ensure that the chunks are evenly distributed in the food composition. Further, the chunks in jelly food compositions of the invention contain less total gums than comparable prior art chunks in jelly food compositions. Less gum mean that the food compositions are more digestible and therefore produce improved fecal quality and consistency for animals consuming the compositions. Similarly, the chunks in jelly food compositions have equal or improved palatability when compared to compatible prior art compositions. The benefits to digestibility, fecal quality and consistency, and palatability were a surprising and unexpected benefit that resulted from the combination of ingredients in the required amounts needed to ensure an even distribution of the chunks in the jelly.

For example, prior art jelly compositions for chunks in jelly food compositions can be made using a combination of ingredients such as those shown in Table 1.

TABLE 1

| Ingredients | % |
|---|---|
| Xanthan (Standard) | 0.06 |
| Guar Gum | 0.56 |
| k-Carrageenan | 0.62 |
| Carob | 0.38 |
| Flavor system (amino acids and sugars) | 1.00 |
| Water | 97.38 |

These prior art food compositions often have an uneven distribution of chunks in the jelly because guar breaks down and decreases in viscosity when hot chunks were mixed with the jelly. The viscosity of the jelly before addition of the hot chunks is about 3000 to 4000 centipoises. After addition of the hot chunks, the viscosity drops to about 500 centipoises. This lower viscosity caused by addition of the hot chunks permits the chunks to move around in the jelly and become unevenly distributed within the jelly.

The jelly composition for chunks in jelly food compositions of the present invention can be made using a combination of ingredients such as those shown in Table 2.

TABLE 2

| Ingredients | % |
|---|---|
| Gellan Gum | 0.25 |
| Xanthan (Deacetylated) | 0.15 |
| Sodium Citrate | 0.20 |
| Calcium Chloride | 0.20 |
| Guar Gum (Optional) | 0.15 |
| Flavor system (amino acids and sugars) | 1.00 |
| Water | 98.05 |

The unique combination of gums in the amounts shown for the invention produces a jelly that maintains its viscosity throughout the process used to produce the chunks in jelly food compositions, including when hot chunks are mixed with the jelly. The viscosity of the jelly before addition of the hot chunks is about 3000 to 4000 centipoises. After addition of the hot chunks, the viscosity remains about 3000 to 4000 centipoises. This viscosity supports the chunks and allows a product with a relatively even distribution of chunks to be produced. Further, the total amount of gum is less compared to the prior art compositions; 1.62% compared to 0.55%. The resulting chunks in jelly food compositions have only about one-third of the quantity of gum in prior art compositions. As a result, the food compositions of the present invention are more digestible and therefore produce improved fecal scores that show that the food compositions improve fecal quality and consistency. Similarly, the chunks in jelly food compositions have equal or improved palatability when compared to compatible prior art compositions.

The chunks in jelly food compositions of the present invention can be prepared by adding the chelating agent to the water at room temperature (RT) (about 15 to 20° C.) and stirring with a high speed mixer for about 1 minute at about 3000 rpm. The chelating agent concentration ranges from about 0.05 to 0.4%. The gellan gum is then added to the water at RT with continued stirring for about 1 minute at about 3000 rpm. The guar gum, the deacetylated xanthan gum, the amino acid and the sugar are added at RT with continued stirring for about 2 minutes at about 3000 rpm. Then, the calcium salt is added at RT and stirred for about 1 minute at about 1500 rpm. The resulting viscosity of the jelly solution is from about 3000 to 4000 cps. The jelly solution is mixed with hot chunks, sealed in a container, retorted, and cooled to produce a chunks in jelly food composition with a uniform distribution of chunks. Similar processes are known to skilled artisans.

In another aspect, the invention provides methods for improving the digestibility of chunks in jelly food compositions compared to prior art chunks in jelly food compositions. The methods comprise manufacturing chunks in jelly food composition using a jelly comprising from about 0.01 to about 1% gellan, from about 0.01 to about 1% deacetylated xanthan, from about 0.01 to about 1% chelating agent, and from about 0.01 to about 1% calcium salt. In a preferred embodiment, the jelly further comprises from about 0.01 to about 1% guar. Typically, the jelly comprises from about 90% to about 98% water. The lower total amount of gums in the composition compared to prior art compositions makes the composition more digestible.

In another aspect, the invention provides methods for improving fecal quality and consistency for animals consuming chunks in jelly food compositions compared to prior art chunks in jelly food compositions. The methods comprise feeding the animal a chunks in jelly food composition comprising chunks in jelly in a chunks to jelly ratio of from about 25:75 to about 60:40, wherein the jelly comprises from about 0.01 to about 1% gellan, from about 0.01 to about 1% deacetylated xanthan, from about 0.01 to about 1% chelating agent, and from about 0.01 to about 1% calcium salt. In most embodiments, the composition comprises from about 90% to about 98% water. In a preferred embodiment, the jelly further comprises from about 0.01 to about 1% guar. The lower total amount of gums in the composition compared to prior art compositions result in an improved fecal quality and consistency for animals consuming the novel chunks in jelly food compositions. Fecal quality (fecal scores) and consistency can be determined by methods known to skilled artisans. For example, fecal scores can be based upon the following characteristics: 1—hard and dry; 2—firm but not hard; 3—solid cylindrical rope with moist surface; 4—very moist surface but still ropelike; 5—very moist with visible ropes in piles; 6—wet mass that occurs as a pile without the rope definition; and 7—watery, runny flat puddles.

In another aspect, the invention provides methods for improving the palatability of chunks in jelly food compositions compared to prior art chunks in jelly food compositions. The methods comprise manufacturing chunks in jelly food composition using a jelly comprising from about 0.01 to about 1% gellan, from about 0.01 to about 1% deacetylated xanthan, from about 0.01 to about 1% chelating agent, and from about 0.01 to about 1% calcium salt. In a preferred embodiment, the jelly further comprises from about 0.01 to about 1% guar. Typically, the jelly comprises from about 90% to about 98% water. The combination of ingredients in the composition compared to prior art compositions makes the composition more palatable.

In another aspect, the invention provides a means for communicating information about or instructions for one or more of (1) the digestibility of the chunks in jelly food compositions of the present invention, (2) using the chunks in jelly food compositions to improve fecal quality and consistency for an animal consuming the food compositions; (3) instructions for feeding the chunks in jelly food compositions to an animal; (4) contact information for consumers to use if they have a question about the chunks in jelly food compositions or their use; and (5) nutritional information about the chunks in jelly food compositions. Useful instructions can include feeding amounts and frequency. The communication means is useful for instructing on the benefits of using the present invention and communicating the approved methods for feeding the food compositions to an animal. The means comprises one or more of a physical or electronic document, digital storage media, optical storage media, audio presentation, audiovisual display, or visual display containing the information or instructions. Preferably, the means is selected from the group consisting of a displayed website, a visual display kiosk, a brochure, a product label, a package insert, an advertisement, a handout, a public announcement, an audiotape, a videotape, a DVD, a CD-ROM, a computer readable chip, a computer readable card, a computer readable disk, a USB device, a FireWire device, a computer memory, and any combination thereof.

In another aspect, the present invention provides a package comprising a chunks in jelly food composition of the present invention and a label affixed to the package containing a word or words, picture, design, acronym, slogan, phrase, or other device, or combination thereof that indicates that the contents of the package contains a chunks in jelly food composition with beneficial properties such as even chunk distribution, improved fecal quality and consistency, improved digestibility, and improved palatability. Typically, such device comprises the words “improves fecal quality”, “improves fecal consistency”, “improved digestibility”, “and enhanced palatability”, or an equivalent expression printed on the package. Any package or packaging material suitable for containing the composition is useful in the invention, e.g., bag, box, bottle, can, pouch, and the like manufactured from paper, plastic, foil, metal, and the like. In a preferred embodiment, the package contains a food composition adapted for a particular animal such as a human, canine, or feline, as appropriate for the label, preferably a companion animal food composition for dogs or cats. In a preferred embodiment, the package is a retortable can or pouch comprising a chunks in jelly food composition of the present invention.

### EXAMPLES

The invention can be further illustrated by the following examples, although it will be understood that these examples are included merely for purposes of illustration and are not intended to limit the scope of the invention unless otherwise specifically indicated.

### Example 1

Chunks having the ingredients shown in Table 3 were manufactured by grinding the meat and meat by-products to sizes less than 12 mm with a meat grinder. Chicken, pork liver, wheat flour, and wheat gluten were ground in a standard meat grinder for 10 minutes at 1000 turns per minute. The meats were then mixed in a paddle blender with the other dry ingredients and water was added to obtain a homogenous elastic paste. The paste was then emulsified with a Karl Schnell Emulsifier. The emulsified paste was then pumped through dies to form ropes. The extruded ropes were treated with continuous hot air and steam to obtain a core temperature of between 80 and 95° C. The thermoset ropes were sliced into slabs at the outlet of the oven. These were then diced to an appropriate size of about 8 to 20 mm on the long side using an Urschel dicer.

TABLE 3

| Ingredients | % |
|---|---|
| Chicken (carcass) and Meat By-Products | 70.00 |
| Cereal | 18.00 |
| Dries | 3.00 |
| Water | 9.00 |

A jelly (control jelly) having the ingredients shown in Table 4 was manufactured using a Karl Schnell B22 mixer. Water at room temperature was weighed and poured into the mixer. The agitator was then set for 3000 rpm. The dry ingredients were added with continuous agitation for about 3 minutes and the solids were homogenously dispersed. The viscosity obtained was 3500 cps (Brookfield RVT, 20 rpm) and shown in Table 6.

TABLE 4

| Ingredients | % |
|---|---|
| Xanthan (Standard) | 0.06 |
| Guar Gum | 0.56 |
| k-Carrageenan | 0.62 |
| Carob | 0.38 |
| Aromatic system (amino acids and sugars) | 1.00 |
| Water | 97.38 |

A jelly (test jelly) having the ingredients shown in Table 5 was manufactured using the Karl Schnell B22 mixer as follows. The chelating agent (0.20% sodium citrate) was added to the water (room temperature (15 to 20° C.) and stirred for 1 minute at 3000 rpm. Then, the 0.15% gellan powder was added to the water and stirred for about 1 minute at 3000 rpm. The 0.15% guar gum powder, the 0.15% deacetylated xanthan gum powder, the amino acid powders, and the sugar powders were added to the water and stirred for an additional 2 minutes at 3000 rpm. At the end, the 0.20% calcium chloride powder was added to the water and stirred for 30 seconds to 1 minute at 1500 rpm. Stirring was soft and controlled so as not to break down the fluid gel of gellan.

TABLE 5

| Ingredients | % |
|---|---|
| Gellan Gum | 0.25 |
| Xanthan (Deacetylated) | 0.15 |
| Sodium Citrate | 0.20 |
| Calcium Chloride | 0.20 |
| Guar Gum (Optional) | 0.15 |
| Aromatic system (amino acids and sugars) | 1.00 |
| Water | 98.05 |

Each jelly was transferred to vacuum filler and added to pouches, 50 grams of jelly per pouch. 45 grams of hot chunks (70 to 85° C.) were added to the jelly in the pouch. The pouches were then vacuum sealed and retorted by heating to 130° C. over 15 minutes; kept at 130° C. for 20 minutes; and cooled to 50° C. in 15 minutes. The pouches were allowed to cool for at room temperature for 2 hours. The pouches were opened and the resulting chunks in jelly food compositions were compared for chunk distribution. In the composition with the control jelly, the chunks had the appearance of settling out from the jelly. There was an upper layer of pure jelly and a lower layer where the chunks were concentrated. In the composition with the test jelly, the chunks were evenly distributed throughout the cooled jelly.

### Example 2

The control jelly and test jelly described in Example 1 were compared to test their viscosity. All viscosity data were obtained at sample temperature of 20° C. using a Brookfield RVT viscometer. The same spindle at 20 rpm was used for all measurements. Results are shown in Table 6. Referring to Table 6, it is clear that the control jelly composition breaks down and loses about 86% of its original viscosity on contact with the hot chunks. The control jelly did not keep the chunks in suspension until the jelly sets. The new jelly composition on the other hand only lost about 15% of its original viscosity on contact with the hot chunks. This was enough to keep the chunks in suspension until the liquid composition set to the jelly and hence maintained the even distribution of the chunks.

TABLE 6

| | Control Jelly | Test Jelly |
|---|---|---|
| Viscosity Before Chunk Addition | 3500 cps | 3500 cps |
| (RT) | | |
| Viscosity After Hot Chunk | 500 cps | 3000 cps |
| Addition (70° C.) | | |

Referring to Table 6, the data shows that the control jelly composition breaks down and loses about 86% of its original viscosity on contact with the hot chunks. The control jelly did not keep the chunks in suspension until the jelly sets. In contrast, the test jelly composition only lost about 15% of its original viscosity on contact with the hot chunks. The chunks remained in suspension until the liquid composition set to jelly. The test jelly composition maintained the even distribution of the chunks.

### Example 3

The control jelly described in Example 1 was transferred to vacuum filler and added to pouches, 50 grams of jelly per pouch. Then 45 grams of cooled (<40° C.) chunks were added to the jelly in the pouch. The pouches were then vacuum sealed and retorted by heating to 130° C. for over 15 minutes; kept at 130° C. for 20 minutes; and cooled to 50° C. in 15 minutes. The pouches were allowed to cool at room temperature for 2 hours. When cooled chunks were added to the control jelly composition, the jelly did not breakdown as it did when hot chunks were added to the composition. The chunks were evenly distributed; they were similar to the chunks in the new jelly composition.

The chunks in jelly composition having the control jelly and the test jelly were each compared for palatability by feeding versus a common competitive product using a standard two-bowl test (two short meals per day for two days). Each product was fed to 40 adult cats of randomized sizes. The results are shown in Table 7.

TABLE 7

| Commercial Chunks | Control Chunk in | Test Chunks in | Significance |
|---|---|---|---|
| in Jelly Product | Jelly Composition | Jelly Composition | p <0.05 |
| 33.4 | 66.6 | | S |
| 23.7 | 76.3 | | S |
| 19.7 | — | 80.3 | S |
| 36.7 | — | 63.3 | S |

Referring to Table 7, the test jelly composition was just as palatable as the control jelly composition and better than the commercial jelly product.

### Example 4

The chunks in jelly product having the control jelly and the test jelly were compared for fecal quality and consistency. Each diet was-fed to a panel of at least 8 healthy adult cats with enough food to meet their nutritional requirements daily for 11 days. Feces from each animal was evaluated daily and scored as follows: 1—hard and dry; 2—firm but not hard; 3—solid cylindrical rope with moist surface; 4—very moist surface but still ropelike; 5—Very moist with visible ropes in piles; 6—wet mass that occurs as a pile without the rope definition; and 7—watery, runny flat puddles. Scores of 1-4 were acceptable and 5-7 were unacceptable. The results are shown in Table 8.

TABLE 8

| | Control Jelly | Test Jelly |
|---|---|---|
| Total Hydrocolloid in | 1.62% | 0.55% |
| the Jelly | | |
| Digestibility Measured | 70% | 95% |
| by Fecal Consistency | Not | Very good |
| | Acceptable | |

Referring to Table 8, the results show a clear improvement in fecal quality and consistency (digestibility) for the test chunks in jelly composition

In the specification, there have been disclosed typical preferred embodiments of the invention. Although specific terms are employed, they are used in a generic and descriptive sense only and not for purposes of limitation. The scope of the invention is set forth in the claims. Obviously many modifications and variations of the invention are possible in light of the above teachings. It is therefore to be understood that within the scope of the appended claims, the invention may be practiced otherwise than as specifically described.

1. A chunks in jelly food composition comprising chunks in jelly in a chunks to jelly ratio of from about 25:75 to about 60:40, wherein the jelly comprises from about 0.01 to about 1% gellan, from about 0.01 to about 1% deacetylated xanthan, from about 0.01 to about 1% chelating agent, and from about 0.01 to about 1% calcium salt.

2. The food composition of claim 1 wherein the jelly further comprises from about 0.01 to about 1% guar.

3. The food composition of claim 1 wherein the jelly comprises from about 0.03 to about 0.7% gellan, from about 0.03 to about 0.7% deacetylated xanthan, from about 0.03 to about 0.7% chelating agent, and from about 0.03 to about 0.7% calcium salt.

4. The food composition of claim 3 wherein the jelly further comprises from about 0.03 to about 0.7% guar.

5. The food composition of claim 1 wherein the jelly comprises from about 0.05 to about 0.5% gellan, from about 0.05 to about 0.5% deacetylated xanthan, from about 0.05 to about 0.5% chelating agent, and from about 0.05 to about 0.5% calcium salt.

6. The food composition of claim 1 wherein the jelly further comprises from about 0.05 to about 0.5% guar.

7. The food composition of claim 1 formulated to provide complete and balanced nutrition for an animal.

8. The food composition of claim 1 wherein the animal is a companion animal.

9. The food composition of claim 8 wherein the animal is a dog or a coat.

10. A jelly composition suitable for use in chunks in jelly food compositions comprising from about 0.01 to about 1% gellan, from about 0.01 to about 1% deacetylated xanthan, from about 0.01 to about 1% chelating agent, from about 0.01 to about 1% calcium salt.

11. The jelly composition of claim 10 further comprising from about 0.01 to about 1% guar.

12. The jelly composition of claim 10 wherein the jelly comprises from about 0.03 to about 0.7% gellan, from about 0.03 to about 0.7% deacetylated xanthan, from about 0.03 to about 0.7% chelating agent, and from about 0.03 to about 0.7% calcium salt.

13. The jelly composition of claim 12 wherein the jelly further comprises from about 0.03 to about 0.7% guar.

14. The jelly composition of claim 10 wherein the jelly comprises from about 0.05 to about 0.5% gellan, from about 0.05 to about 0.5% deacetylated xanthan, from about 0.05 to about 0.5% chelating agent, and from about 0.05 to about 0.5% calcium salt.

15. The jelly composition of claim 14 wherein the jelly further comprises from about 0.05 to about 0.5% guar.

16. (canceled)

17. (canceled)

18. A method for improving fecal quality and consistency for animals consuming chunks in jelly food compositions comprising feeding the animal a chunks in jelly food composition comprising chunks in jelly in a chunks to jelly ratio of from about 25:75 to about 60:40, wherein the jelly comprises from about 0.01 to about 1% gellan, from about 0.01 to about 1% deacetylated xanthan, from about 0.01 to about 1% chelating agent, and from about 0.01 to about 1% calcium salt.

19. The method of claim 18 wherein the jelly further comprises from about 0.01 to about 1% guar.

20. (canceled)

21. (canceled)

22. (canceled)

23. (canceled)

24. (canceled)

25. (canceled)
